(19) United States
(12) Patent Application Publication
(10) Pub. No.: US 2024/0246165 A1
(43) Pub. Date: Jul. 25, 2024

(54) Submerged Arc Welding Method and Submerged Arc Welding Machine

(71) Applicant: DAIHEN Corporation, Osaka (JP)

(72) Inventors: Hayato Baba, Osaka (JP); Reo Honda, Osaka (JP); Yuichi Miyajima, Osaka (JP); Yuki Narisada, Osaka (JP)

(21) Appl. No.: 18/404,312

(22) Filed: Jan. 4, 2024

(30) Foreign Application Priority Data
Jan. 25, 2023 (JP) 2023-009535

(51) Int. Cl. B23K 9/18

(52) U.S. Cl. CPC B23K 9/182

(57) ABSTRACT

A submerged arc welding method comprises setting a first welding condition under which first average welding current is supplied to a welding wire; and setting a second welding condition under which second average welding current is supplied to a welding wire, and the first welding condition and the second welding condition are periodically switched.

### CROSS-REFERENCE TO RELATED APPLICATIONS

This non-provisional application claims priority under 35 U.S.C. § 119(a) on Patent Application No. 2023-9535 filed in Japan on Jan. 25, 2023, the entire contents of which are hereby incorporated by reference.

### BACKGROUND ART

The present disclosure relates to a submerged arc welding method and a submerged arc welding machine.

A technique is disclosed of adjusting the depth of penetration in AC submerged arc welding by regulating a ratio of the period during which positive voltage is applied to a welding wire and the period during which negative voltage is applied to the welding wire and by regulating effective current flowing during the respective periods (Takafumi Miyata, Digital Controlled Submerged Arc Welding Power Source Equipped with Waveform Control Faculty, Journal of the Japan Welding Society, 2008, Vol. 77, issue 7, p. 635-639). The periods to be regulated are positive and negative periods appearing in a single period of alternating current.

### DESCRIPTION

An object of the present disclosure is to provide a submerged arc welding method and a submerged arc welding machine that can achieve deeper penetration.

A submerged arc welding method according to one aspect of the present disclosure is a submerged arc welding method comprising: setting a first welding condition under which first average welding current is supplied to a welding wire; and setting a second welding condition under which second average welding current is supplied to a welding wire, and the first welding condition and the second welding condition are periodically switched.

A submerged arc welding machine according to one aspect of the present disclosure is a submerged arc welding machine comprising a control device that sets a first welding condition under which first average welding current is supplied to a welding wire and a second welding condition under which second average welding current is supplied to a welding wire, and the control device periodically performs switching between the first welding condition and the second welding condition.

According to one aspect of the present disclosure, deeper penetration can be obtained.

The above and further objects and features will more fully be apparent from the following detailed description with accompanying drawings.

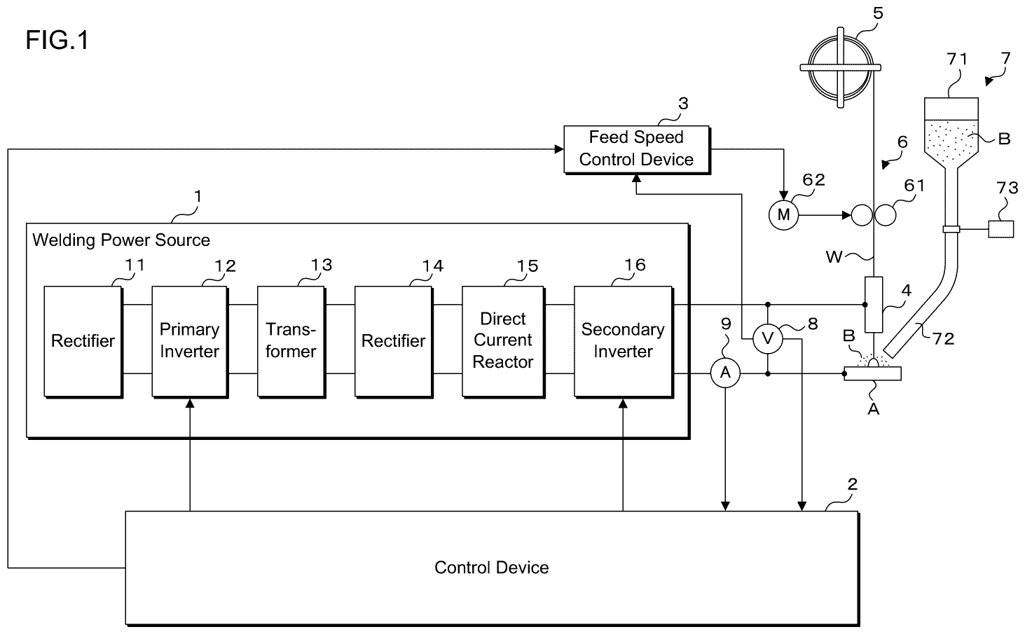

FIG. 1 is a schematic diagram illustrating one configuration of a submerged arc welding machine according to the present embodiment.

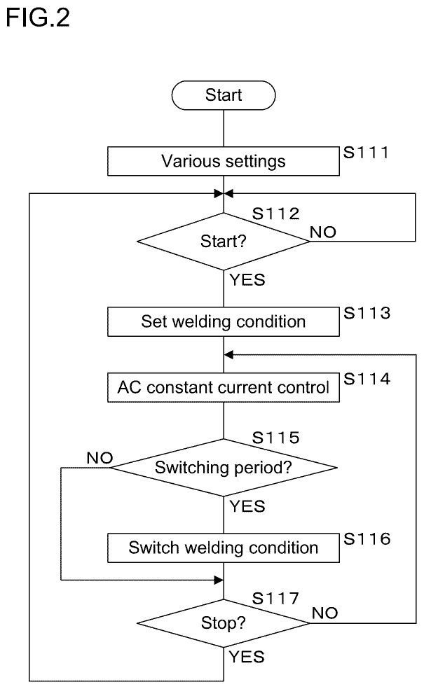

FIG. 2 is a flowchart showing a procedure of a submerged arc welding method according to the present embodiment.

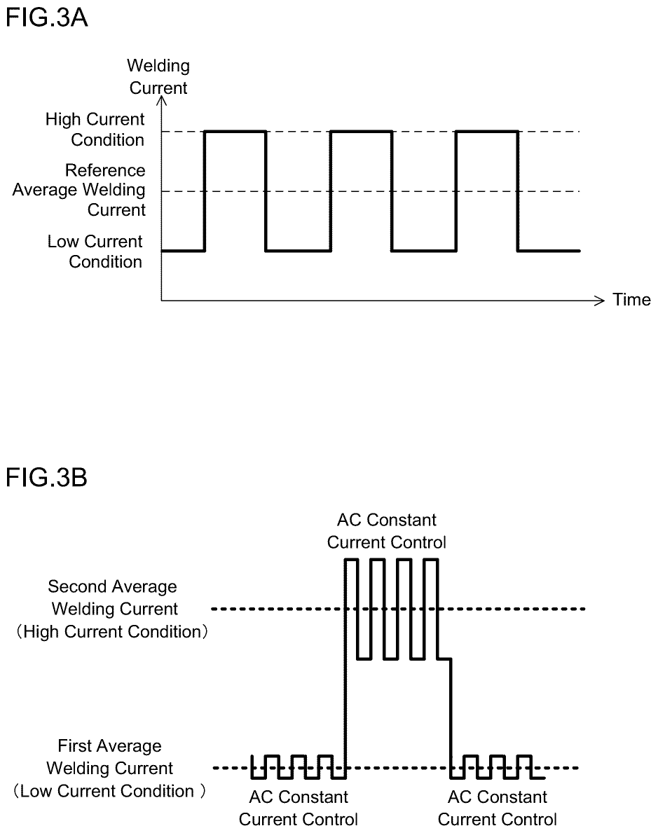

FIG. 3A is a timing chart according to the present embodiment representing a state where a low current period and a high current period are periodically switched.

FIG. 3B is a timing chart according to the present embodiment representing a state where a low current period and a high current period are periodically switched.

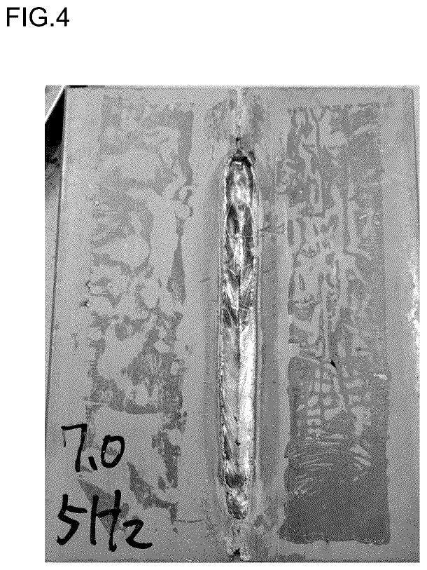

FIG. 4 is a photograph of the backside of a base material welded by the submerged arc welding method according to the present embodiment.

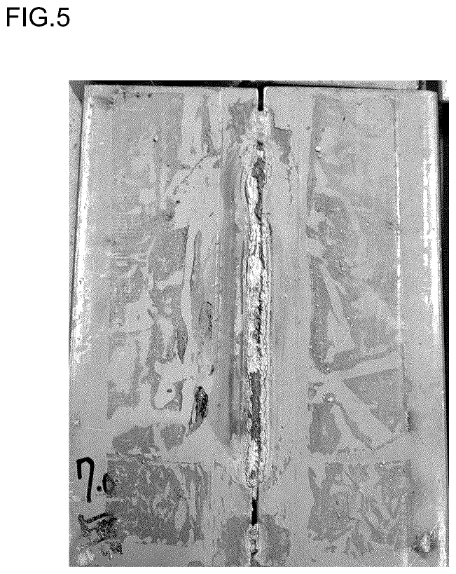

FIG. 5 is a photograph of the backside of a base material welded by a conventional submerged arc welding method.

Specific examples of a submerged arc welding method and a submerged arc welding machine according to an embodiment of the present disclosure will be described below with reference to the drawings. Note that the present invention is not limited to these examples. The scope of the present invention is defined by the appended claims, and all changes that fall within the meanings and the bounds of the claims, or equivalence of such meanings and bounds are intended to be embraced by the claims.

The present disclosure will be described below with reference to the drawings depicting embodiment thereof.

### Submerged Arc Welding Machine

FIG. 1 is a schematic diagram illustrating one configuration of a submerged arc welding machine according to the present embodiment. The submerged arc welding machine according to the present embodiment includes a welding power source 1, a control device 2, a feed speed control device 3, a torch 4, a wire reel 5, a wire feed unit 6, a flux supply mechanism 7, a voltage sensor 8 and a current sensor 9.

The torch 4, which is made of a conducting material such as a copper alloy or the like, guides a welding wire W to a part to be welded of a base material A and has a cylindrical contact tip to supply welding current necessary for formation of an arc. The contact tip is in contact with the welding wire W inserted therethrough and supplies welding current to the welding wire W.

The wire feed unit 6 is provided with feed rollers 61 for drawing out the welding wire W wound around the wire reel 5 and feeding it to the torch 4, and a motor 62 for rotating the feed rollers 61. The wire feed unit 6 feeds the welding wire W to the torch 4 by rotating the feed rollers 61. The feed speed of the welding wire W is adjusted according to the welding voltage so that the arc length does not vary.

The feed speed of the welding wire W by the wire feed unit 6 is controlled by the feed speed control device 3. The arc length is proportional to the welding voltage (arc voltage). The welding voltage is voltage between the contact tip of the torch 4 and the base material A, and detected by the voltage sensor 8. A feed speed setting value as a target value is set to the feed speed control device 3 by the control device 2. The feed speed control device 3 controls the feed speed of the welding wire W so that the arc length is constant while regarding the difference between the feed speed setting value and the welding voltage detected by the voltage sensor 8 as an operating amount.

The voltage sensor 8 is a sensor for detecting voltage between an arc voltage detection lead attached to the torch 4 and an arc voltage detection lead attached to the base material A as welding voltage (arc voltage) and outputting a voltage value signal indicating the detected voltage value to the control device 2 and the feed speed control device 3.

The current sensor 9 is a sensor for detecting welding current that is supplied from the welding power source 1 to the welding wire W via the torch 4 and flows into the base material A through the arc and outputting a current value signal indicating the detected current value to the control device 2.

The flux supply mechanism 7 is equipped with a flux hopper 71, a nozzle 72 and a valve 73 and a flux recovery machine (not illustrated). The flux hopper 71 stores flux B injected from the top and supplies the flux B to a to-be welded part of the base material A through the nozzle 72 connected to the bottom thereof. The valve 73, which is for opening or closing a passage extending from the flux hopper 71 to the nozzle 72, adjusts the supply amount of the flux B. The operation and the degree of opening and closing of the valve 73 are controlled by the control device 2.

The welding power source 1 is an inverter-controlled AC welding power source with a constant-current characteristic and is provided with a rectifier 11, a primary inverter 12, a transformer 13, a rectifier 14, a direct current reactor 15 and a secondary inverter 16 that are connected in series in this order from the input side of a commercial power supply. The welding power source 1 is connected to the contact tip of the torch 4 and the base material A through a power cable. The welding power source 1 receives an input from the commercial power source and supplies welding power between the welding wire W and the base material A to generate an arc.

The rectifier 11 rectifies alternating current from the commercial power source and outputs the rectified current to the primary inverter 12. The primary inverter 12, which operates at a high frequency ranging from ten-odd to several tens of kHz, outputs high-frequency alternating current to a primary coil of the transformer 13. The transformer 13 transforms the alternating current which is then rectified at the rectifier 14 to be output to the second inverter 16 via the direct current reactor 15. The secondary inverter 16, which operates at a low frequency of several tens to several hundred of Hz, outputs low-frequency alternating current. The output of the alternating current causes application of AC welding voltage between the torch 4 and the base material A, which causes the welding current supplied from the welding power source 1 to flow from the torch 4 to the welding wire W through the power cable. With the heating of an arc generated between the base material A and the welding wire W by the welding current, welding of the base material A is performed. The arc is covered with flux B supplied by the flux supply mechanism 7.

The control device 2 is a circuit for outputting control signals to the primary inverter 12 and the secondary inverter 16 of the welding power source 1 and digitally controlling the respective inverters separately. The control device 2 is a processor including an arithmetic processing circuit such as a CPU, a multi-core CPU and the like, a storage device such as a ROM (Read only Memory), an EEPROM and a RAM (Random Access Memory) and input/output terminals. The input/output terminals are connected to the voltage sensor 8, the current sensor 9, the primary inverter 12, the secondary inverter 16, the feed speed control device 3, the valve 73 and an operation panel (not illustrated). The control device 2 performs PWM control on the primary inverter 12 to operate at constant current characteristic based on the set welding conditions and the detected welding current and welding voltage. Required welding voltage is applied between the base material A and the welding wire W to allow the welding current to flow.

### Outline of Submerged Arc Welding Method According to Present Embodiment

In the description below, the average values (the average value of the absolute values in the case where the output is alternating current) of the welding current and the welding voltage output from the welding power source 1 are referred to as output current and output voltage.

One of the typical welding processes with high efficiency for thick plates is submerged arc welding. In submerged arc welding, incomplete penetration often presents a problem, especially in single pass welding or in the first layer of multi-layer welding. Especially when penetration bead welding using a backing material is performed, incomplete welding is likely to occur, including lack of a penetration bead and lack of the fusion width of the backside bead.

In order to prevent incomplete penetration, deep penetration, which needs large output current and small output voltage, is effective. The lower the output voltage is, the shorter the arc length is, resulting in deeper penetration. The output current and the output voltage often have ranges specified by the construction guidelines, standards or the like and are not always freely adjustable. In addition, when the output current and the output voltage are manipulated, the wire feed speed changes, which involves management of the changes in the amount of weld metal. Especially when the output current is increased, the heat input in welding increases, resulting in impairment of the mechanical performance of the to-be welded part. For the forgoing reasons, a method for preventing incomplete penetration without changing the output current and output voltage is desired.

As a method for reducing incomplete welding, a technique of adjusting penetration depth in AC submerged arc welding has been developed by adjusting the ratio of the periods during which positive and negative voltages are applied to the welding wire W and the effective current during the respective periods as presented in the foregoing non-patent document 1.

The above-mentioned technique, however, can only be applied to AC welding, not to DC welding. In addition, the above-mentioned technique alone may not necessarily have sufficient effect on improvement in penetration and thus needs a further method for improving penetration.

### Current Amplitude Control

Hence, in the present embodiment, by periodically alternating the output current between the low current period and the high current period, the molten metal is pushed down with strong arc force during the high current period, and high heat input is applied to the deep part of the molten metal or the base material A to achieve deep penetration. Especially, in the case of performing penetration bead welding using a backing material, a significant penetration bead formation effect can be obtained. The ranges of conditions are indicated below.

The diameter of the welding wire W is 1.2 mm or greater. The welding wire W with a diameter smaller than 1.2 mm makes it difficult to stably maintain submerged arc welding. Since wires with a diameter of 1.6 mm or greater are often used for the submerged arc welding application, a wire with a diameter of 1.6 mm or greater is desirable. More preferably, the wire diameter of the welding wire W is between 2.4 mm and 6.4 mm inclusive that are well distributed in the market for the application of submerge arc welding.

The reference average welding current is equal to or more than 200 A. This reference average welding current is the average value of the welding current over the entire period, including the low current periods and high current periods. This is the reference current for the output current in the low current periods and the output current for the high current periods.

The reference average welding current below 200 A makes it difficult to stably maintain the submerged arc welding, even with the use of a welding wire W of a smaller diameter. The reference average welding current of 350 A or above is preferable since the penetration bead welding requires setting of the welding condition that can obtain deep penetration at a somewhat high current. More preferably, the reference average welding current is between 500 A and 2000 A inclusive, which is often applied as a welding condition in the submerged arc welding. The fluctuation range of the current relative to the reference average welding current, i.e., the difference between the output current (first average welding current) under the low current condition (first average welding condition) and the output current (second average welding current) under the high current condition (second welding condition) is equal to or more than 100 A. If below 100 A, the fluctuation range of the current is too small to obtain a noticeable effect. More preferably, the above-mentioned fluctuation range of the current is between 200 A and 500 A inclusive. A significant penetration bead formation effect can be obtained if the fluctuation range of the current is equal to or more than 200 A while unstable welding is likely to occur if the fluctuation range of the current exceeds 500 A.

The setting value of the wire feed speed may be made constant, or may be changed between the high current condition and the low current condition. Changing the setting value of the wire feed speed between the high current condition and the low current condition relatively causes unstable welding but has a greater penetration bead formation effect.

Note that the welding power source 1 performs AC constant current control in which the wire feed speed increases or decreases relative to the setting value due to the control for maintaining the arc length even if the setting value of the wire feed speed is constant.

The frequency at which current is varied is preferably equal to or higher than 1 Hz. If the frequency is lower than 1 Hz, the duration of the low current period and the high current period is too long to form a continuous deep penetration bead. Furthermore, longer duration of the high current period is more likely to destabilize welding. More preferably, the frequency is equal to or higher than 3 Hz and lower than 10 Hz. When the frequency is equal to or higher than 3 Hz, the duration of the high current period is short enough not to affect the stability of the welding. Note that when the frequency is equal to or higher than 10 Hz, the duration of the low current period and the high current period is too short to obtain the penetration bead formation effect. Note that if the AC frequency of the welding current is equal to or higher than 20 Hz, the period at which the low current period and the high current period are switched may be set in the range between 1 Hz or higher and below 20 Hz. Depending on the welding conditions, a penetration bead formation effect may be obtained even if the period at which the low current period and the high current period are switched is set in a range between 10 Hz or higher and below 20 Hz.

The time ratio between the low current period and the high current period is preferably in the range of 1:3 to 3:1 and more preferably 1:1. The welding current for each of the low current period and the high current period is determined by the reference average welding current, the above-mentioned fluctuation range of current and time ratio of the respective periods. Therefore, if there is a deviation in either side beyond the above-mentioned time ratio, deviation in current is also increased, which prevents stable welding. It should be noted that the output current in the high current period multiplied by the time period of the high current period may desirably be made equal to the output current in the low current period multiplied by the time period of the low current period.

The target to which the submerged arc welding method according to the present embodiment is applied is desirably single pass welding or the first layer of multi-layer welding. Note that since the deep penetration is less required in the second layer or later of the multi-layer welding, the present control does not produce a significant effect when applied, but it presents no problem if applied.

More preferably, the submerged arc welding method in the present embodiment may be applied to a pass where deep penetration bead welding is performed using a backing material such as flux B, copper plate, ceramic backing or the like.

FIG. 2 is a flowchart showing a procedure of a submerged arc welding method according to the present embodiment. First, a pair of base materials A to be joined together by welding is placed on the submerged arc welding machine, and various settings are performed (step S111). After completion of the various settings, the control device 2 determines whether or not a condition for starting the output of the welding current is satisfied (step S112). Specifically, the control device 2 determines whether or not an output instruction signal for welding is input. If determining that the output instruction signal is not input and that the condition for starting the output of the welding current is not satisfied (step S112: NO), the control device 2 is placed in the wait state of waiting for the input of an output instruction signal.

If it is determined that the condition for starting the output of the welding current is satisfied (step S112: YES), the control device 2 sets the low current condition as an initial state, for example (step S113). Then, the control device 2 controls the feed speed and output of the welding wire W based on the set welding condition to perform welding control with AC constant current (step S114).

The feed speed of the welding wire W is controlled with reference to the set feed speed so that the welding voltage is constant, i.e., the arc length is constant. The control device 2 detects the welding voltage and welding current at the voltage sensor 8 and the current sensor 9, respectively and controls the outputs of the primary inverter 12 and the secondary inverter 16 so that the detected welding voltage and welding current satisfy the constant current characteristic of the welding power source 1 and match the set welding condition.

Next, the control device 2 determines whether or not the switching period has arrived (step S115). The switching frequency is lower than 10 Hz. The control device 2 determines whether or not the time corresponding to the period of the switching frequency has elapsed since the current welding condition was set. If it is determined that the switching period has arrived (step S115: YES), the control device 2 switches the welding condition (step S116). If the low current condition is set, the control device 2 sets the welding condition to the high current condition. If the high current condition is set, the control device 2 sets the welding condition to the low current condition.

If completing the processing at step S116, or if determining that the switching period has not yet arrived (step S115: NO), the control device 2 determines whether or not the output of the welding current is to be stopped (step S117). Specifically, the welding power source 1 determines whether or not the output instruction signal is continuously input. If determining that the output instruction signal is continuously input and the output of welding current is not stopped (step S117: NO), the control device 2 returns the processing to step S114 to continue to output the welding current.

If determining that the output of the welding current is stopped (step S117: YES), the control device 2 returns the processing to step S112.

FIGS. 3A and 3B is a timing chart representing a state where a low current period and a high current period according to the present embodiment are periodically switched. The horizontal axis represents the time while the vertical axis represents the welding current. By the processing at steps S115 and S116, the low current condition and the high current condition are periodically switched, to periodically change the output current, which is the average value of the welding current, as illustrated in FIG. 3A.

In addition, as illustrated in FIG. 3B, AC constant current control is performed in each of the low current period and the high current period to output AC welding current of a square wave relative to the average welding current for each of the low current period and the high current period. Though the example illustrated in FIG. 3B shows an example where the amplitude of the AC waveform is set to the magnitude of the first average welding current or the second average welding current, the method of setting the amplitude of the AC current is not limited to a particular method. Though, in the example illustrated in FIG. 3B, a square wave AC is represented as an example of an AC waveform, the type of AC waveform is not limited to a particular one.

### Example

An example of the submerged arc welding method according to the present embodiment is described.

In the present example, a low carbon steel base material A of 19 mm thick with a V groove of 70 degrees is prepared, and butt submerged arc welding is performed on the base material A. The root surface is 0 mm, the gap is 0 mm, and the backing material employs ceramic backing. The welding position is assumed to be vertically downward, and the welding speed is assumed to be 25 cm/min. The welding wire W employs a solid iron wire having a wire diameter of 1.6 mm, and the flux B employs a bonded flux. The wire extension is assumed to be 30 mm (route-to-chip distance). The reference average welding current is assumed to be 350 A, and AC constant current welding is employed as the welding method. The AC waveform is a square wave with a frequency of 60 Hz, and the peak current is successively changed so that the average current for the respective periods match the set current. The wire feed speed is assumed to be constant feed speed of 6.5 m/min. Welding is performed in both cases where control according to the present embodiment is applied and not applied. In the case where control according to the present embodiment is applied, welding current is repeatedly varied at the frequency of 5 Hz assuming that the low current condition is 250 A and the high current condition is 450 A. The ratio between the respective periods is assumed as 1:1.

FIG. 4 is a photograph of the backside of a base material A welded by the submerged arc welding method according to the present embodiment while FIG. 5 is a photograph of the backside of a base material A welded by a conventional submerged arc welding method. When welding is performed under the above-mentioned conditions, a narrow and discontinuous deep penetration bead can be formed in the case where the control related to the present embodiment is not applied while a wide and stable deep penetration bead can be formed in the case where the control related to the present embodiment is applied, as illustrated in FIGS. 4 and 5.

The submerged arc welding method and the submerged arc welding machine according to the first embodiment can obtain deeper penetration than the control of adjusting the waveform in a single period of alternating current and can promote the formation of a deep penetration bead especially in the case where deep penetration welding is performed.

Although the submerged arc welding method using AC constant current control was described in the present embodiment, the submerged arc welding method according to the present embodiment may also be applied to a submerged arc welding method using DC constant voltage control, AC constant voltage control or DC constant current control.

Generally, the submerged arc welding includes AC welding and DC welding, and the control method includes constant current control and constant voltage control. Any combination may be applied without being limited to a specific method or characteristic. Here, in order to facilitate switching between on and off of the control and setting of various parameters, the digital-inverter-controlled welding power source 1 is preferable. Furthermore, in the case where the wire feed speed is changed between the high current period and the low current period, the wire feed speed is required to be switched with good response, so that the use of a digitally-controlled wire feed device is desirable.

Moreover, by setting the period at which the output current is periodically changed to below 10 Hz, the penetration bead formation effect as illustrated in FIG. 4 can be obtained while formation of discontinuous penetration bead is reduced.

Additionally, by setting the reference average welding current to 200 A and the fluctuation range of the output current to 100 A or more, a significant penetration bead formation effect can be obtained.

In addition, by setting the reference average welding current to 350 A, the average welding current under the low current condition to 250 A, and the average welding current under the high current condition to 350 A, deep penetration can be obtained owing to high current (350 A or more) and a significant effect of penetration bead formation can be obtained owing to increase of the fluctuation range of the output current to 100 A or more.

The measures to resolve the problem of the present disclosure are further described.

### Clauses

1. A submerged arc welding method comprising:
setting a first welding condition under which first average welding current is supplied to a welding wire; and
setting a second welding condition under which second average welding current is supplied to a welding wire, wherein
the first welding condition and the second welding condition are periodically switched.

2. The submerged arc welding method according to clause 1, wherein the first welding condition and the second welding condition are switched at a frequency lower than 10 Hz.

3. The submerged arc welding method according to clause 1 or 2, wherein
under the first welding condition and the second welding condition, reference average welding current for welding current is 200 A or higher and a fluctuation range of average welding current is 100 A or higher.

4. The submerged arc welding method according to any one of clauses 1 to 3 further comprising supplying welding current by AC constant current control of 10 Hz or higher.

5. The submerged arc welding method according to any one of clauses 1 to 4 further comprising supplying welding current by AC constant current control of 10 Hz or higher, wherein
under the first welding condition and the second welding condition, reference average welding current for welding current is 350 A, first average welding current is 250 A and second average welding current is 350 A, and switching is performed at a frequency of 5 Hz.

It is to be noted that, as used herein and in the appended claims, the singular forms “a”, “an”, and “the” include plural referents unless the context clearly dictates otherwise.

It is to be noted that the disclosed embodiment is illustrative and not restrictive in all aspects. The scope of the present invention is defined by the appended claims rather than by the description preceding them, and all changes that fall within metes and bounds of the claims, or equivalence of such metes and bounds thereof are therefore intended to be embraced by the claims.

What is claimed is:

1. A submerged arc welding method comprising:
setting a first welding condition under which first average welding current is supplied to a welding wire; and
setting a second welding condition under which second average welding current is supplied to a welding wire, wherein
the first welding condition and the second welding condition are periodically switched.

2. The submerged arc welding method according to claim 1, wherein the first welding condition and the second welding condition are switched at a frequency lower than 10 Hz.

3. The submerged arc welding method according to claim 2, wherein
under the first welding condition and the second welding condition, reference average welding current for welding current is 200 A or higher and a fluctuation range of average welding current is 100 A or higher.

4. The submerged arc welding method according to claim 1 further comprising supplying welding current by AC constant current control of 10 Hz or higher.

5. The submerged arc welding method according to claim 1, further comprising supplying welding current by AC constant current control of 10 Hz or higher, wherein
under the first welding condition and the second welding condition, reference average welding current for welding current is 350 A, first average welding current is 250 A and second average welding current is 350 A, and switching is performed at a frequency of 5 Hz.

6. A submerged arc welding machine, comprising:
a control device that sets a first welding condition under which first average welding current is supplied to a welding wire and a second welding condition under which second average welding current is supplied to a welding wire, wherein
the control device periodically performs switching between the first welding condition and the second welding condition.
